(19) United States
(12) Patent Application Publication
(10) Pub. No.: US 2018/0274851 A1
(43) Pub. Date: Sep. 27, 2018

(54) REFRIGERATOR LED ILLUMINATOR WITH TUBULAR HOUSING AND INTERNAL LENS

(71) Applicant: NUALIGHT LIMITED, Cork (IE)

(72) Inventors: Brian NORRIS, Slieverue (IE); Eamonn HAWE, Ballincollig (IE); John KENNEDY, Carrigaline (IE)

(73) Assignee: NUALIGHT LIMITED, Cork (IE)

(21) Appl. No.: 15/538,071

(22) PCT Filed: Dec. 21, 2015
(86) PCT No.: PCT/EP2015/080875

§ 371 Date: Jun. 20, 2017

(30) Foreign Application Priority Data
Dec. 22, 2014 (EP) 14199806.2

(51) Int. Cl. F25D 27/00; A47F 3/00; F21S 4/20; F21V 5/04; F21V 15/01; F21V 15/015; F21V 29/76; F21V 5/00

(52) U.S. Cl. CPC F25D 27/005; A47F 3/001; F21S 4/20; F21V 5/04; F21W 2131/305; F21V 15/015; F21V 29/763; F21V 5/008; F21V 15/013

(57) ABSTRACT

An illuminator has an elongate tubular body containing LEDs on a substrate and a lens forming a bridge over the LEDs. The tubular housing has a transparent top part to act as an outer lens and diffuser. The housing is connected at each end to an end cap via a resilient seal which is moulded into the end cap. The internal lens is compact and provides a versatile choice of illuminator configuration for desired illumination. A convex curved lower lens s profile ensures efficient transmission of emitted light without colour separation. The extent of sealing is very short due to the closed tube nature of the housing and the short perimeters for sealing of the ends of the body to the end caps.

### INTRODUCTION

### Field of the Invention

The invention relates to an LED (light emitting diode) illuminator for refrigerated cabinets or the like applications.

### Prior Art Discussion

It is known to provide LED illuminators for refrigerated cabinets and the like situations where there may be physical contact with items and potential moisture ingress. The latter is a particular problem in refrigerated cabinets, and it can over time cause shorts in the LED drive circuits or other optical or electrical problems.

US2010/0214785 (Chen) describes an LED luminaire having a transparent tubular enclosure inside which there is a lamp seat, an LED module, a reflector, an LED driver, and a power cable. Waterproof devices seal the ends of the enclosure.

US2005/0265019 (Sommers et al) describes an LED luminaire for product display cases. It comprises an elongate base and an inverted U-shaped transparent enclosure over the base.

US2012/0250302 (Edwards) describes a vapour-tight lighting fixture having a sealed tubular housing and end caps sealing the ends of the housing. Fluorescent lamps are within the housing.

The invention is directed towards providing an LED illuminator which is improved in terms of sealing to prevent moisture ingress, is compact, and/or is efficient in illuminating at wide angles to a plane normal to the plane of the LEDs. Another objective is to achieve versatility in choice of output light pattern during manufacturing or subsequent modification.

The invention is directed towards providing an illuminator with improvements in some or all of the above aspects.

### SUMMARY OF THE INVENTION

According to the invention, there is provided an illuminator comprising:
an elongate tubular housing extending in a longitudinal direction and having a transparent material,
an elongate internal support extending along and within at least some of the housing, LEDs on a substrate on the support,
end caps connected to the ends of the housing, at least one of said end caps having terminals for power connections,
in which,
the illuminator comprises an internal lens (20) within the housing and bridging over the LEDs.

In one embodiment, the lens comprises a pair of opposed legs along at least part of its length and a lensing portion extending between the legs and forming a bridge over the LEDs. In one embodiment, said legs are arranged to rest on a substrate for the LEDs or on the internal support. In one embodiment, the lensing portion comprises a convex curved surface facing the LEDs. Preferably, the curved surface is configured for initial collimation of emitted light.

In one embodiment, the internal lens comprises a ridge offset laterally from a longitudinal axis of the LEDs, the ridge being shaped to direct the majority of emitted light laterally with respect to a longitudinal axis of the illuminator. In one embodiment, there is a pair of offset ridges, one on each lateral side of the LED longitudinal axis.

In one embodiment, the support is of a metal, having high thermal conductivity. Preferably, the support is of extruded aluminium.

In one embodiment, the support comprises elongate heat dissipation fins on a lower portion opposed to the LEDs.

In one embodiment, the housing is of co-extruded transparent and opaque plastics materials, having a transparent portion above the LEDs for light emission and having an opaque portion on a side opposed to a light-emitting side.

In one embodiment, the illuminator further comprises slidable brackets arranged to grip opposed lateral sides of the housing and to fasten to an external body. Preferably, the housing comprises opposed ridges (8) for gripping by the brackets.

In one embodiment, the housing is configured to converge to a narrower shape towards a top portion over the LEDs.

In one embodiment, the end caps have pins for engaging in sockets on the substrate for the LEDs. In one embodiment, the end caps have an external socket for connection to external pins.

In one embodiment, each end cap forms a recess to receive an end of the housing, and has a resilient seal for contact with an end edge of the housing. Preferably, the seal is affixed to the end cap. In one embodiment, the seal in moulded into the end cap.

In one embodiment, the majority of the LEDs have a CRI greater than 90. In one embodiment, at least some of the LEDs each has a footprint of equal to or less than 4 mm².

In one embodiment, the illuminator further comprises at least one end bracket attached to an end cap and being arranged to engage a support.

In one embodiment, the end bracket is U-shaped with one flange engaging the end cap across its face, and a substantially parallel spaced-apart flange which is bent to a flat portion for engagement with a support.

In another aspect, the invention provides a display cabinet comprising an illuminator as defined above in any embodiment mounted to a frame member of said display cabinet.

### Additional Statements

According to the invention, there is provided an illuminator comprising:
an elongate body containing LEDs on a substrate and a lens, the body being at least partially transparent to act as an outer lens, and
end caps connected to the body and having terminals for power connections.

In one embodiment, the lens has a ridge offset laterally from a longitudinal axis of the LEDs, the ridge being shaped to direct the majority of light laterally. In one embodiment, there is a pair of offset ridges, one on each lateral side of the LED axis.

In one embodiment, the lens and the LEDs are on an elongate support housed within the tubular housing. In one embodiment, the support is of a material such as Al, having high thermal conductivity. In one embodiment, the support has heat dissipation fins on a lower portion. In one embodiment, said fins are elongate.

In one embodiment, the end caps have pins for engaging in sockets on the substrate for the LEDs. In one embodiment, the end caps have an external socket for connection to external pins.

In one embodiment, each end cap forms a recess to receive an end of the tubular housing, and has a resilient seal for contact with an end edge of the tubular housing. In one embodiment, the seal is affixed to the end cap. In one embodiment, the seal in moulded-in.

In one embodiment, the majority of the LEDs have a CRI greater than 90. In one embodiment, each LED has a footprint of equal to or less than 4 mm² and they are arranged so that light being refracted via the lens does not suffer from colour separation.

In one embodiment, the lens is of co-extruded transparent and opaque plastics materials for illumination on only one side of the illuminator.

In one embodiment, the illuminator further comprises slidable brackets arranged to grip opposed lateral sides of the tubular body and to fasten to a support.

In one embodiment, the tubular body as opposed ridges for gripping by the brackets.

In one embodiment, the illuminator further comprises at least one end bracket attached to an end cap and being arranged to engage a support.

In one embodiment, the end bracket is U-shaped with one flange engaging the end cap across its face, and a substantially parallel spaced apart flange which is bent to a flat portion for engagement with a support.

### DETAILED DESCRIPTION OF THE INVENTION

The invention will be more clearly understood from the following description of some embodiments thereof, given by way of example only with reference to the accompanying drawings in which:—

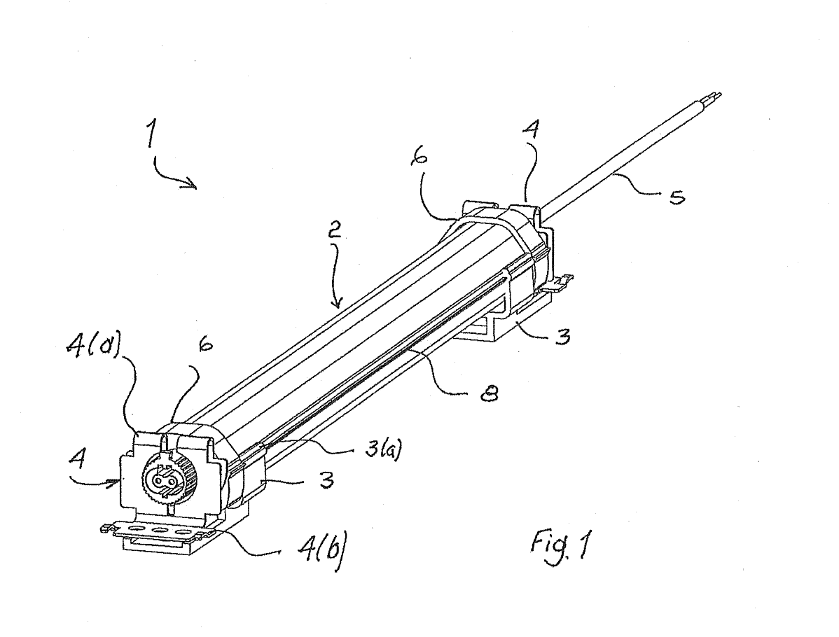

FIG. 1 is a perspective view of an illuminator of the invention;

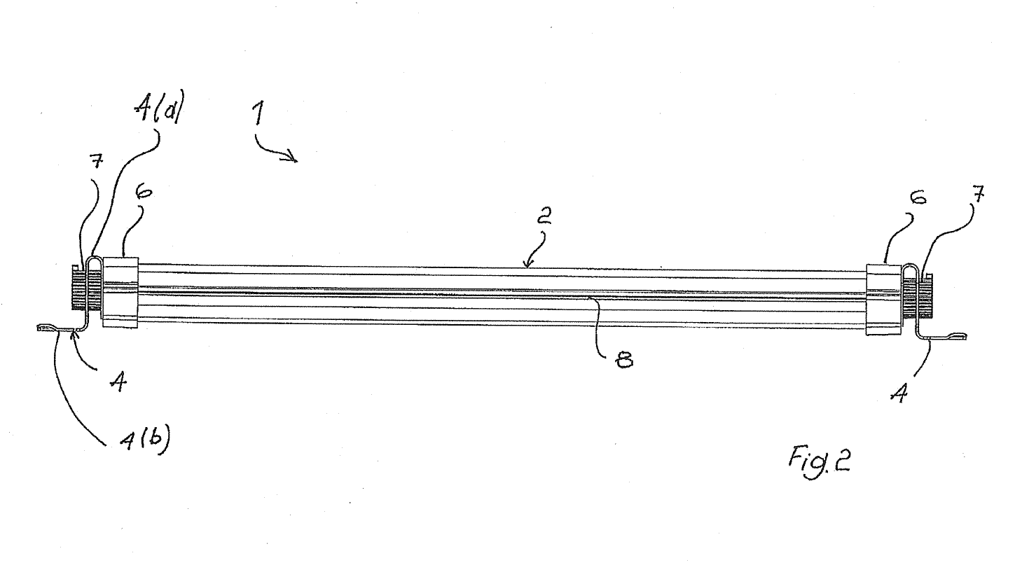

FIG. 2 is a side view with two of the brackets removed;

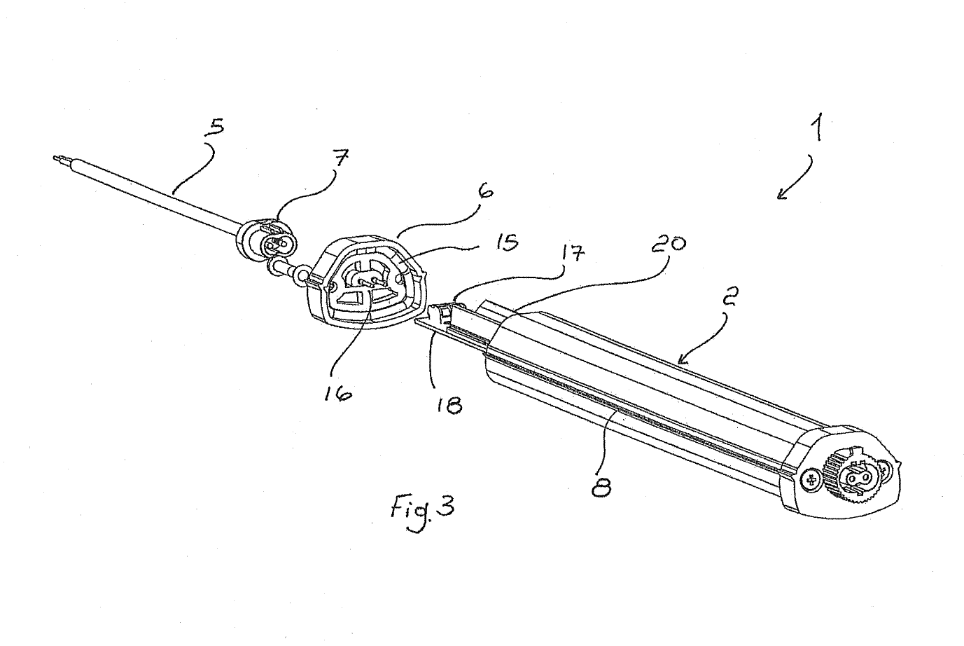

FIGS. 3 and 4 are perspective views with one end exploded, including details of an end cap;

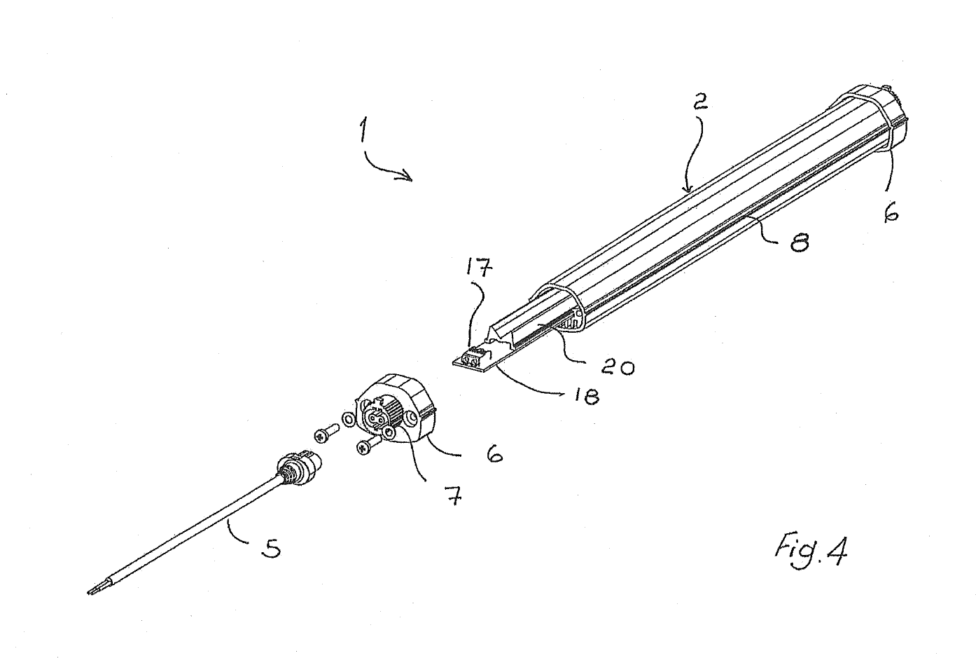

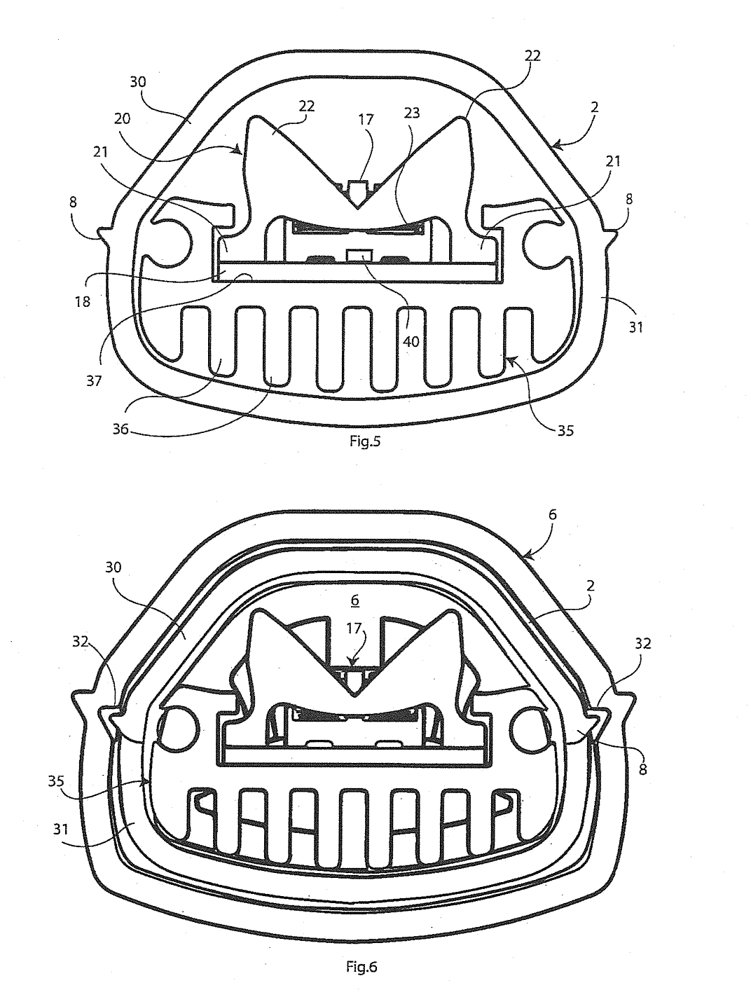

FIG. 5 is a diagrammatic cross-sectional view through the illuminator, and FIG. 6 is a similar view including an end cap;

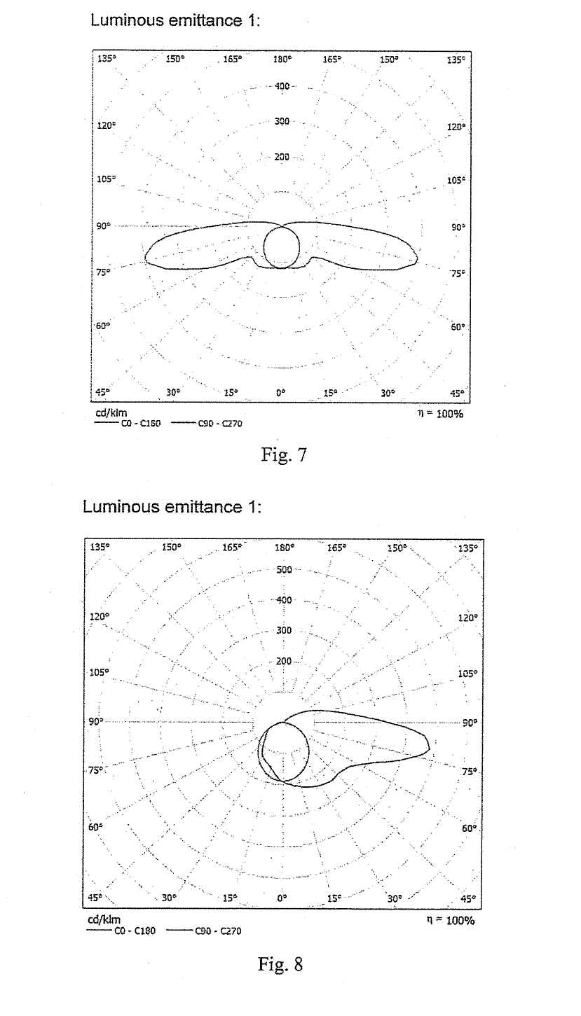

FIG. 7 is a luminous emittance plot illustrating the light pattern for the illuminator of FIGS. 1 to 6;

FIG. 8 is a luminous emittance plot for an alternative embodiment in which the internal lens is extruded to have one lateral side opaque; and

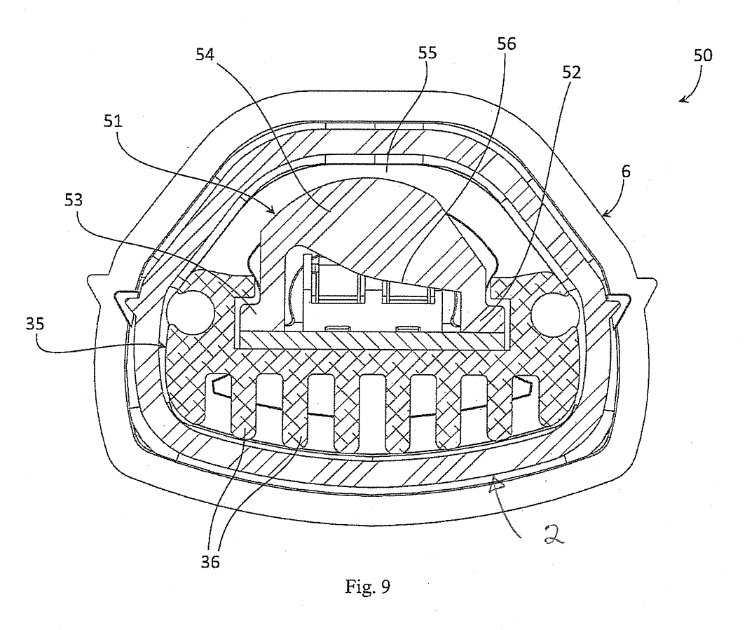

FIG. 9 is a cross-sectional view through an illuminator of an alternative embodiment, having a different internal lens.

### DESCRIPTION OF THE EMBODIMENTS

Referring to FIGS. 1 to 7 an illuminator 1 comprises a tubular housing 2, to which may be attached sliding mounting brackets 3. There are end caps 6 sealing the ends of the housing 2, outside of which are end brackets 4, and illuminator power sockets 7 directed axially.

The sliding brackets 3 may be slid to any desired location along the length of the housing 2 for mounting. This is by virtue of an elongate snap-filing groove 3(a) engaging a pair of opposed lateral ridges 8 on the housing 2.

As shown particularly in FIG. 2 the brackets 4 have a U-shaped part 4(a) with an inner flange in contact with the end cap 6 and an outer flange which is bent to a flat portion 4(b).

As shown particularly in FIGS. 3 and 6 each end cap 6 has a moulded-in rubber seal 15 around its internal corner, and two power pins 16 extend inwardly into the housing 2. The pins 16 protrude from an illuminator socket 7 extending axially from each end, and are arranged to receive a plug on a cable 5 for power and signals.

The housing 2 comprises a transparent upper portion 30 which acts as a diffuser and lens. This portion is above the ridges 8. The housing 2 is completed by an opaque lower portion 31 below the ridges 8. The materials of the housing 2 are polymer-based, either polycarbonate or acrylic, extruded to any desired length.

The tubular housing 2 encloses an elongate metal aluminium support 35 with elongate heat-dissipation fins 36 along its lower side. It fits inside the housing 2, conforming in its outer surfaces with the internal curvature of the housing 2 at its opaque lower part 31.

The support 35 also comprises an upper platform 37 supporting an elongate PCB 18, in turn supporting and interconnecting a linear array of LEDs 40.

An extruded symmetrical lens 20 is mounted on the support 35. The material of the lens 20 is polycarbonate. The lens 20 forms a bridge along and over the LED array 40. There is a leg 21 on each side, resting on the PCB 18 along the side edges of the PCB 18. The lens 20 also comprises a pair of ridges 22, one on each side of the PCB 18 centre line, and separated by a trough-shaped bridge.

The optical arrangement of the lens 20 ensures that the maximum amount of light is refracted to the required target area while minimising the amount of stray light. The emission angle of the lens 20 is +/−70°, as shown in FIG. 7. This ensures that light is directed laterally to the sides for illumination across the face of a freezer or cooler, for example. This is a very advantageous emission angle for uniform illumination across the front faces of goods on display.

The lens 20 forms a convex curved surface 23 directly over, aligned with, and facing the LEDs 40. This part of the lens ensures that there is initial collimation of the emitted LED light, and helps to avoid colour separation. It has been found that a convex lens surface facing the LEDs allows particularly efficient direction of emitted light out through the housing portion 30. Also, the distance between the LEDs and the convex surface 23 is at a maximum by virtue of the lens forming a bridge over the LEDs and being as close as possible to the housing 2. This allows optimum efficiency of light harnessing from the LEDs at their beam angle. Also, the curvature allows the light to be focused, creating a large peak intensity. Also, the continuous nature of the curved surface over the LEDs contributes to avoidance of colour separation. In general, the convex curved surface facing the LEDs focuses the light into a uniform beam before being spread in the desired manner by the upper portions of the lens.

The arrangement of the lens and the housing allows one single line of LED's to have their flux spread into two separate beams of light in the embodiment of FIGS. 1 to 7. The ‘M’ formed lens controls the light by the internal ‘V’ to split the initial LED's light into two whilst the outer ‘M’ forms control and focuses the light where required. An extruded form of this nature is a particularly effective way to split light initially and equally about the centre of an LED array. It is particularly advantageous that the lens 20 is shaped so that the LEDs 40 are within the form and are positioned so that the maximum amount of flux can be captured by the lens in order for optimal optical control.

There is excellent versatility because any desired internal lens may be provided which has a configuration to bridge over the LED array and fit within the housing. For example, the illuminator may have a lens with the same shape as the lens 20, but one lateral side may be of opaque material, achieved by co-extrusion. This would provide illumination in one lateral side only, providing an optical pattern as shown in FIG. 8. Such a lens would be manufactured by co-extruding transparent and opaque plastics materials, in which the opaque material is on one side, about one third of the volume, and the remainder is the transparent material for direction of light laterally on its side.

The housing 2 acts as a diffuser and also as a lens. The extent of diffusion can be chosen at manufacture or at later modification by choice of housing 2, which is modular. In these embodiments the housing does not alter the optical direction to any significant extent and so the lensing effect of the housing is minimal, however the diffusing and lensing effects can be chosen to suit the application by choice of housing shape and surface texture for any manufacture.

To ensure quality product presentation in a retail environment LEDs using only greater than 90 CRI are used in the array 40. Each LED has a footprint of equal to or less than 4 mm², 2 mm*1.6 mm in one preferred example. This helps to ensure that the light being refracted via the optical system does not suffer from colour separation which is known when using large devices and is not desired in the application.

The luminaire may, for example, be placed horizontally to create a uniform asymmetric distribution down the vertical face of a chiller and under shelves. In another configuration the luminaire may have a lens to provide a more diffuse appearance with a smooth and uniform light emission.

It will be appreciated that the illuminator is very well sealed to prevent moisture ingress, because the only seals are at the ends and are very short, around the periphery of the ends of the housing 2. There is excellent versatility by choice of lengths of the elongate parts. Also, it has a very low profile due to the lens and housing arrangement.

Other advantageous aspects are small form factor due to the compactness of the components within the housing 2. This is especially helped by the fact that the housing 2 is wider in its lower part, and narrowing to form a wide ridge along its top surface. Also, the top part 30 of the housing 2 provides a fully diffused appearance.

Another example of versatility is shown in FIG. 9, in which parts similar to those in FIGS. 1 to 7 are given the same reference numerals. An illuminator 50 has the same housing 2, end caps 6, and support 35 as the illuminator 1. In this case however, a lens 51 has legs 52 and 53 to enable it to extend over the LED array 40. It has a lensing portion 54 with a curved top surface and a lower convex surface 56 facing the LEDs 40. This provides an optical output as shown in FIG. 11. The lens 51 harnesses the light from the LEDs and focuses it into a uniform single beam which has a larger peak at the right side as viewed in FIG. 9. The lens therefore provides an homogenous flux level down a given surface when mounted in a position such as horizontal position above a display cabinet.

The invention is not limited to the embodiments described but may be varied in construction and detail. For example the invention may be applied to illuminators for non-refrigerated cabinets, or other confined spaces such as along retail display shelves.

1. An illuminator comprising:
an elongate tubular housing extending in a longitudinal direction and having a transparent material,
an elongate internal support extending along and within at least some of the housing,
LEDs on a substrate on the support,
end caps connected to the ends of the housing, at least one of said end caps having terminals for power connections,
characterized in that,
the illuminator comprises an internal lens within the housing and bridging over the LEDs.

2. The illuminator as claimed in claim 1, wherein the lens comprises a pair of opposed legs along at least part of its length and a lensing portion extending between the legs and forming a bridge over the LEDs.

3. The illuminator as claimed in claim 1, wherein the lens comprises a pair of opposed legs along at least part of its length and a lensing portion extending between the legs and forming a bridge over the LEDs; and wherein said legs are arranged to rest on a substrate for the LEDs or on the internal support.

4. The illuminator as claimed in claim 1, wherein the lens comprises a pair of opposed legs along at least part of its length and a lensing portion extending between the legs and forming a bridge over the LEDs; and wherein the lensing portion comprises a convex curved surface facing the LEDs.

5. The illuminator as claimed in claim 1, wherein the lens comprises a pair of opposed legs along at least part of its length and a lensing portion extending between the legs and forming a bridge over the LEDs; and wherein the lensing portion comprises a convex curved surface facing the LEDs; and wherein the curved surface is configured for initial collimation of emitted light.

6. The illuminator as claimed in claim 1, wherein the internal lens comprises a ridge offset laterally from a longitudinal axis of the LEDs, the ridge being shaped to direct the majority of emitted light laterally with respect to a longitudinal axis of the illuminator.

7. The illuminator as claimed in claim 1, wherein the internal lens comprises a ridge offset laterally from a longitudinal axis of the LEDs, the ridge being shaped to direct the majority of emitted light laterally with respect to a longitudinal axis of the illuminator; and wherein there is a pair of offset ridges, one on each lateral side of the LED longitudinal axis.

8. The illuminator as claimed in claim 1, wherein the support is of a metal, having high thermal conductivity.

9. The illuminator as claimed in claim 1, wherein the support is of a metal, having high thermal conductivity; and wherein the support is of extruded aluminium.

10. The illuminator as claimed in claim 1, wherein the support comprises elongate heat dissipation fins on a lower portion opposed to the LEDs.

11. The illuminator as claimed in claim 1, wherein the housing is of co-extruded transparent and opaque plastics materials, having a transparent portion above the LEDs for light emission and having an opaque portion on a side opposed to a light-emitting side.

12. The illuminator as claimed in claim 1, further comprising slidable brackets arranged to grip opposed lateral sides of the housing and to fasten to an external body; and wherein the housing comprises opposed ridges for gripping by the brackets.

13. (canceled)

14. (canceled)

15. The illuminator as claimed in claim 1, wherein the end caps have pins for engaging in sockets on the substrate for the LEDs.

16. The illuminator as claimed in claim 1, wherein the end caps have an external socket for connection to external pins.

17. The illuminator as claimed in claim 1, wherein each end cap forms a recess to receive an end of the housing, and has a resilient seal for contact with an end edge of the housing.

18. The illuminator as claimed in claim 1, wherein each end cap forms a recess to receive an end of the housing, and has a resilient seal for contact with an end edge of the housing; and wherein the seal is affixed or moulded to the end cap.

19. (canceled)

20. The illuminator as claimed in claim 1, wherein a majority of the LEDs have a CRI greater than 90.

21. The illuminator as claimed in claim 1, wherein at least some of the LEDs each has a footprint of equal to or less than 4 mm².

22. The illuminator as claimed in claim 1, further comprising at least one end bracket attached to an end cap and being arranged to engage a support.

23. The illuminator as claimed in claim 1, further comprising at least one end bracket attached to an end cap and being arranged to engage a support; and wherein the end bracket is U-shaped with one flange engaging the end cap across its face, and a substantially parallel spaced-apart flange which is bent to a flat portion for engagement with a support.

24. A display cabinet comprising an illuminator as claimed in claim 1 mounted to a frame member of said display cabinet.
